(19) United States
(12) Patent Application Publication
(10) Pub. No.: US 2012/0093109 A1
(43) Pub. Date: Apr. 19, 2012

(54) RANDOM ACCESS PROCESSING METHOD AND USER EQUIPMENT

(75) Inventors: Ning Dong, Beijing (CN); Jianbo Hu, Beijing (CN)

(73) Assignee: Huawei Technologies Co. Ltd., Shenzhen (CN)

(21) Appl. No.: 13/276,961

(22) Filed: Oct. 19, 2011

(30) Foreign Application Priority Data
Oct. 19, 2010 (CN) 201010516541.1

(51) Int. Cl. H04W 74/04; H04W 76/00

(52) U.S. Cl. 370/329

(57) ABSTRACT

A random access processing method and User Equipment (UE) are provided in the present invention. The method includes: after receiving current Random Access Response (RAR) information sent from an evolved Node B (eNB), comparing current uplink grant information in the current RAR information with pre-stored uplink grant information, where the pre-stored uplink grant information is uplink grant information in previous RAR information received in a previous random access process; performing data scheduling and packetization according to the current uplink grant information to generate a first data packet carrying a UE identifier when the current uplink grant information is not consistent with the pre-stored uplink grant information; sending the first data packet to the eNB, and receiving a second data packet from the eNB; and parsing the second data packet, and determining whether contention-based random access is successful according to a parsing result.

### CROSS-REFERENCE TO RELATED APPLICATIONS

This application claims priority to Chinese Patent Application No. 201010516541.1, filed on Oct. 19, 2010, which is hereby incorporated by reference in its entirety.

### FIELD OF THE INVENTION

The embodiments of the present invention relate to the field of communications technologies, and in particular, to a random access processing method and User Equipment (UE).

### BACKGROUND OF THE INVENTION

With the 3rd Generation (hereinafter referred to as 3G) mobile communication technology as a main technology for radio communications, the Universal Mobile

Telecommunications System (hereinafter referred to as UMTS) specified by the 3rd Generation Partnership Project (hereinafter referred to as 3GPP) is influential in the industry. To further enhance the position of the 3GPP in wireless technology standards, a Long Term Evolution (hereinafter referred to as LTE) system is introduced into 3GPP technologies, which focuses on Orthogonal Frequency-Division Multiplexing (hereinafter referred to as OFDM), and meanwhile adopts technologies such as Multiple-Input Multiple-Output (hereinafter referred to as MIMO) and 64 Quadrature Amplitude Modulation (hereinafter referred to as 64 QAM), so that the network performance can be significantly improved.

In the LTE system, when User Equipment (hereinafter referred to as UE) accesses a radio network for the first time, the UE selects a Preamble sequence and sends the Preamble sequence to an evolved Node B (hereinafter referred to as eNB) to request for access to the radio network. After receiving the Preamble sequence, the eNB assigns a Random Access Response (hereinafter referred to as RAR) for the UE, where the RAR includes uplink grant information. Then, the eNB sends the assigned RAR to the UE, so that the UE performs data scheduling and packetization according to the uplink grant information in the RAR to obtain a Message 3 (hereinafter referred to as Msg3) which is generally a Radio Resource Control (hereinafter referred to as RRC) connection request, and sends the Msg3 to the eNB so as to request for establishing a radio connection with the eNB. When an environment of a radio channel is poorer, the UE often cannot successfully access the radio network during the first random access, and the UE may be required to perform the random access request for more than two times, and send the same Msg3 to request for establishing a radio connection with the eNB.

In the implementation of the present invention, the inventor finds that the prior art has at least the following problems. When the UE performs the preceding random access for the second time, if a cell where the UE is located is currently in a Radio Resource Control CONNECTED (hereinafter referred to as RRC_CONNECTED) state, that is, under a nearly full load condition, in order to enable more UEs to access the radio network, the eNB reduces corresponding uplink grant resources allocated to the RAR corresponding to the UE for the current access request, causing that the uplink grant is not consistent with the uplink grant of the previous access, thus resulting in a failure of access of the UE when the UE sends the Msg3 to the eNB to request for establishing a radio connection with the eNB.

### SUMMARY OF THE INVENTION

Embodiments of the present invention provide a random access processing method and a UE, so as to improve a random access success rate during a random access process.

An embodiment of the present invention provides a random access processing method, which includes:

after receiving current RAR information sent from an eNB, comparing current uplink grant information in the current RAR information with pre-stored uplink grant information, where the pre-stored uplink grant information is uplink grant information in previous RAR information received in a previous random access process;

when the current uplink grant information is not consistent with the pre-stored uplink grant information, performing data scheduling and packetization according to the current uplink grant information to generate a first data packet carrying a UE identifier;

sending the first data packet to the eNB, and receiving a second data packet from the eNB; and

parsing the second data packet, and determining whether contention-based random access is successful according to a parsing result.

An embodiment of the present invention provides a UE, which includes:

a comparison processing module, after receiving current RAR information sent from an eNB, configured to compare current uplink grant information in the current RAR information with pre-stored uplink grant information, where the pre-stored uplink grant information is uplink grant information in previous RAR information received in a previous random access process;

a scheduling and packetization module, when the current uplink grant information is not consistent with the pre-stored uplink grant information, configured to perform data scheduling and packetization according to the current uplink grant information to generate a first data packet carrying a UE identifier;

a first processing module, configured to send the first data packet to the eNB, and receive a second data packet from the eNB; and

a second processing module, configured to parse the second data packet, and determine whether contention-based random access is successful according to a parsing result.

With the random access processing method and the UE according to the embodiments of the present invention, the current uplink grant information in the current RAR information received by the UE from the eNB is compared with the pre-stored uplink grant information in the previous RAR, and if the current uplink grant information is different from the pre-stored uplink grant information, data scheduling and packetization is performed according to the current uplink grant information to generate a first data packet carrying a UE identifier; and the first data packet is sent to the eNB equipment. In this way, a situation in the prior art, where the data packet obtained by scheduling and packetization according to the grant information in the RAR received during the previous access request is still sent to the eNB when the current grant information is different from the previous grant information, is changed. Therefore, by using the technical solutions according to the embodiments of the present invention, the success rate of random access of the UE can be effectively improved.

### BRIEF DESCRIPTION OF THE DRAWINGS

To describe the technical solutions in the embodiments of the present invention or in the prior art more clearly, the accompanying drawings required for describing the embodiments or the prior art are introduced briefly in the following. Apparently, the accompanying drawings in the following description are only some embodiments of the present invention, and persons of ordinary skill in the art may also derive other drawings from these accompanying drawings without creative efforts.

FIG. 1 is a flow chart of a random access processing method according to a first embodiment of the present invention;

FIG. 2 is a flow chart of a random access processing method according to a second embodiment of the present invention;

FIG. 3 is a schematic structural diagram of a UE according to a third embodiment of the present invention;

FIG. 4 is a schematic structural diagram of a UE according to a fourth embodiment of the present invention;

FIG. 5 is a schematic structural diagram of a UE according to a fifth embodiment of the present invention; and

FIG. 6 is a schematic structural diagram of a random access processing system according to a sixth embodiment of the present invention.

### DETAILED DESCRIPTION OF THE EMBODIMENTS

In order to make the objectives, technical solutions, and advantages of the embodiments of the present invention clearer, the technical solutions in the embodiments of the present invention are clearly and fully described in the following with reference to the accompanying drawings in the embodiments of the present invention. Obviously, the embodiments to be described are only a part rather than all of the embodiments of the present invention. Based on the embodiments of the present invention, all other embodiments obtained by persons of ordinary skill in the art without creative efforts shall fall within the protection scope of the present invention.

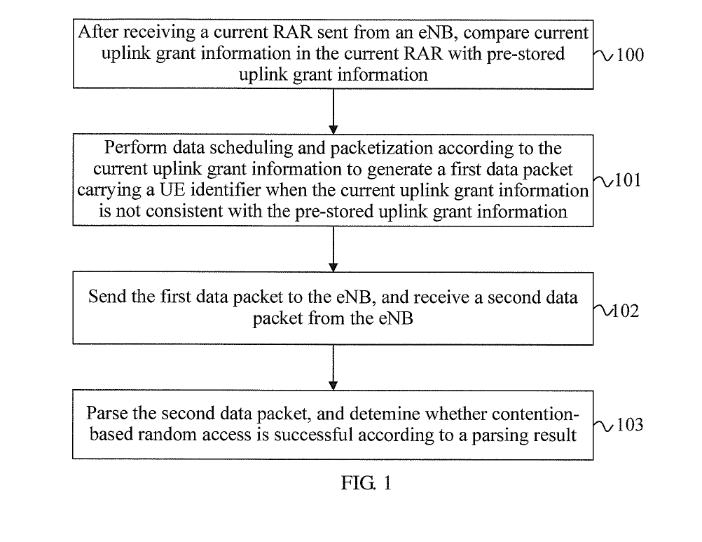

FIG. 1 is a flow chart of a random access processing method according to a first embodiment of the present invention. The executive subject of the random access processing method in this embodiment is a UE. As shown in FIG. 1, the random access processing method in this embodiment may specifically include the following steps.

Step 100: After receiving a current RAR sent from an eNB, compare current uplink grant information in the current RAR with pre-stored uplink grant information.

Here, the pre-stored uplink grant information is uplink grant information in previous RAR information received by the UE from the eNB in a previous random access process.

Specifically, the random access processing method in this embodiment occurs in a non-first random access request process of the UE. In a random access request process before the current random access request, the random access of the UE may fail due to a poorer radio environment. Alternatively, a previous random access request is also a non-first random access request, and uplink grant information in an RAR received from the eNB in the previous random access request process is different from uplink grant information in an RAR received from the eNB in a process before the previous random access request process; but the UE still sends a message obtained by scheduling and packetization according to the uplink grant information in the RAR received in the process before the previous random access request process to the eNB so as to request for establishing a radio connection. In this way, even if the radio environment is good, the eNB still sends a message indicating a failure of contention-based access to the UE after receiving the message.

In this embodiment, in the current random access request process, after receiving the current RAR information sent from the eNB, the UE first compares the current uplink grant information in the current RAR information with the pre-stored uplink grant information in the previous RAR information received by the UE from the eNB in the previous random access process. It should be noted that, in any random access request process, an RAR received by the UE may include uplink grant information, a Time Alignment (hereinafter referred to as TA) value and a Cell Radio Network Temporary Identifier (hereinafter referred to as C-RNTI).

Step 101: When the current uplink grant information is not consistent with the pre-stored uplink grant information, perform data scheduling and packetization according to the current uplink grant information to generate a first data packet carrying a UE identifier.

Specifically, when the UE determines that the current uplink grant information received in the current random access request process is not consistent with the pre-stored uplink grant information received in the previous random access request process, that is, the pre-stored uplink grant information, the UE performs data scheduling and packetization according to the current uplink grant information received in the current random access request process to generate a first data packet carrying a UE identifier. The first data packet may be an Msg3.

Step 102: Send the first data packet to the eNB, and receive a second data packet from the eNB.

Specifically, after the UE obtains the Msg3 by scheduling and packetization according to step 101, the UE sends the Msg3 to the eNB. After receiving the Msg3, the eNB may parse the Msg3 to obtain a UE identifier from the Msg3. After obtaining the UE identifier, the eNB generates a second data packet carrying the UE identifier according to the UE identifier, or generates a second data packet by scrambling control information including the UE identifier. Then, the eNB sends the second data packet to the UE. Correspondingly, the UE receives the second data packet from the eNB. The second data packet may be referred to as Message4 (hereinafter referred to as Msg4, a contention resolution message).

Step 103: Parse the second data packet and determine whether contention-based random access is successful according to a parsing result.

It should be noted that, when a radio network condition is bad, the UE may fail to send the Msg3 to the eNB, and the eNB neither generates nor sends the Msg4 to the UE. At this time, according to the system setting, the UE may receive a response message indicating a failure of sending of the Msg3. However, sometimes because a network state is not good, a long waiting time is required for the UE to receive the Msg4 or the response message indicating the failure of sending, and in order to improve the efficiency of random access, a timer may be set at the UE side. When the UE fails to receive the response message indicating the failure of sending of the Msg3 or fails to receive the Msg4 sent from the eNB within a preset time period, it may be considered that the current contention-based random access fails, so as to perform a next random access request in time. In this way, the efficiency of random access can be effectively improved.

With the random access processing method in this embodiment, the current uplink grant information in the current RAR information received by the UE from the eNB is compared with the pre-stored uplink grant information in the previous RAR, and when the current uplink grant information is different from the pre-stored uplink grant information, data scheduling and packetization is performed according to the current uplink grant information to generate a first data packet carrying a UE identifier; and the first data packet is sent to the eNB. In this way, a situation in the prior art, where the data packet obtained by scheduling and packetization according to the grant information in the RAR received during the previous access request is still sent to the eNB when the current grant information is different from the previous grant information, is changed. Therefore, by using the technical solution in this embodiment, the success rate of random access of the UE can be effectively improved.

It should be noted that, on the basis of the preceding embodiment, the comparing the current uplink grant information in the current RAR with the pre-stored uplink grant information in step 100 may specifically be: comparing a size of a Transport Block (hereinafter referred to as TB) of the current uplink grant information in the current RAR with a size of a TB of the pre-stored uplink grant information to determine whether the current uplink grant information is the same as the pre-stored uplink grant information.

It should be noted that, after step 102 of the preceding embodiment, the method may further include: updating the pre-stored uplink grant information to the current uplink grant information. Specifically, each time after a data packet obtained by scheduling and packetization is sent to the eNB, regardless of whether the current contention-based random access of the UE succeeds, the UE may still update the pre-stored uplink grant information to the current uplink grant information. In this way, it may be ensured that the pre-stored uplink grant information is always uplink grant information in a previous random access request process.

It should be noted that, step 102 of the preceding embodiment may specifically adopt the following manner: sending the first data packet to the eNB, so that the eNB parses the first data packet to obtain a UE identifier in the first data packet, generates a second data packet carrying the UE identifier, and sends the second data packet to the UE.

Correspondingly, in step 103 of the preceding embodiment, the receiving the second data packet, parsing the second data packet, and determining whether the contention-based random access is successful according to the parsing result may specifically include the following steps: (a) receiving the second data packet; (b) parsing the second data packet to obtain a UE identifier in the second data packet; and (c) comparing the obtained UE identifier with the UE identifier carried in the first data packet, and if the two are consistent, determining that the contention-based random access is successful; otherwise, determining that the contention-based random access fails.

Specifically, because multiple UEs may request the eNB for random access at the same time, and the eNB processes first data packets of multiple UEs at the same time, the eNB first needs to parse and obtain a UE identifier in a first data packet when processing each first data packet, and then generates a second data packet carrying the UE identifier. For details of a specific generation method, see the description of the preceding embodiment. Then, the eNB sends the second data packet to a UE corresponding to the UE identifier. However, because the eNB processes multiple UEs at the same time, inevitably, the eNB may send a second data packet that should be sent to another UE to the UE by mistake. Therefore, after receiving the second data packet, the UE parses the second data packet to obtain a UE identifier in the second data packet. Then, the UE compares the received UE identifier with the UE identifier carried in the first data packet, and if the two are consistent, the UE may determine that the current contention-based random access is successful; otherwise, the UE determines that the current contention-based random access fails.

It should be noted that, before step 100 of the preceding embodiment, the method may further include the following steps.

(1) Send a current random access request to an eNB.

(2) Receive a current RAR sent from the eNB according to the current random access request.

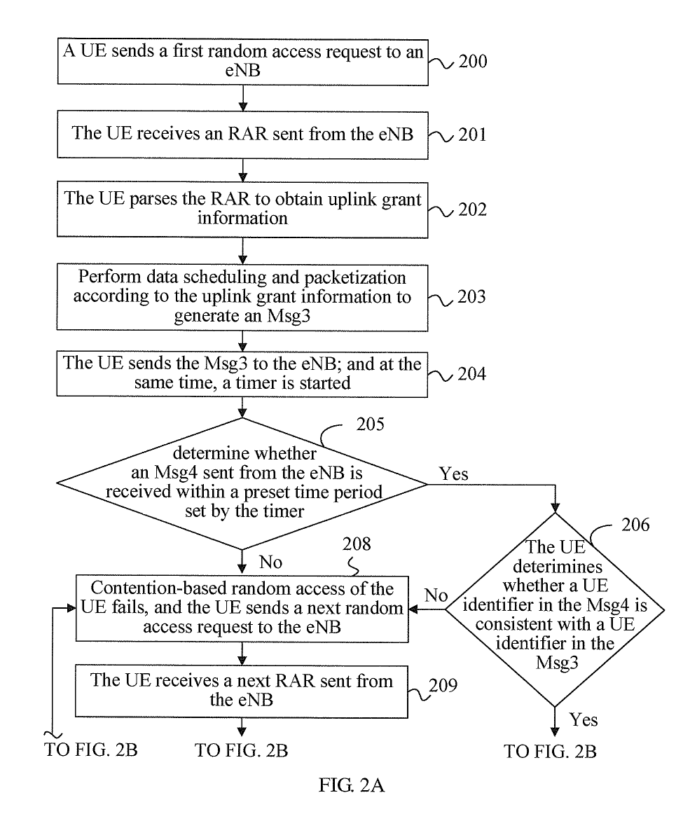

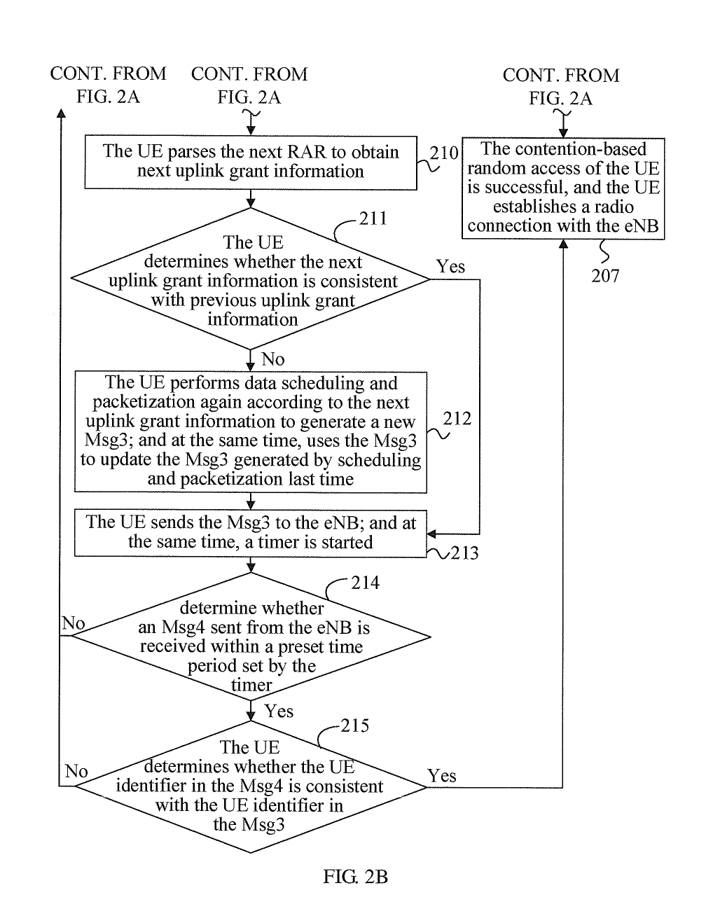

FIG. 2 is a flow chart of a random access processing method according to a second embodiment of the present invention. As shown in FIG. 2, the random access processing method in this embodiment may specifically include the following steps.

Step 200: A UE sends a first random access request to an eNB; and step 201 is performed.

Specifically, this step occurs in a random access process based on contention resolution, where the UE is triggered by Media Access Control (hereinafter referred to as MAC), a Physical Downlink Control Channel (hereinafter referred to as PDCCH) command or Radio Resource Control (hereinafter referred to as RRC) under such conditions that the UE triggers reestablishment due to handover or a failure of an initial request for accessing a radio network or radio link.

For the first random access request sent from the UE, the UE may specifically select a Preamble sequence as random access request information, and send the Preamble sequence to the eNB to request for establishing a radio network connection with the eNB.

Step 201: The UE receives an RAR sent from the eNB; and step 202 is perform

The RAR is assigned for the UE by the eNB according to the received first random access request such as the Preamble sequence. The RAR includes uplink grant information, a TA value and a C-RNTI that are assigned for the first random access request.

Step 202: The UE parses the RAR to obtain the uplink grant information; and step 203 is performed.

Step 203: Perform data scheduling and packetization according to the uplink grant information to generate an Msg3; and step 204 is performed.

The Msg3 includes an identifier of the UE.

Specifically, the uplink grant information here includes a size of a TB. Here, the Msg3 also needs to be stored at the same time.

Step 204: The UE sends the Msg3 to the eNB; at the same time, a timer is started; and step 205 is performed.

Step 205: Determine whether an Msg4 sent from the eNB is received within a preset time period set by the timer; and if the Msg4 sent from the eNB is received within the preset time period, step 206 is performed, or if the Msg4 sent from the eNB is not received within the preset time period set by the timer, step 208 is performed.

The Msg4 is generated by the eNB according to the UE identifier in the Msg3 received from the UE, and the Msg4 carries the UE identifier.

If the Msg4 sent from the eNB is not received within the preset time period, the following cases may be included: the UE may fail to send an Msg3 due to a poorer radio network environment, and correspondingly the UE may receive a message indicating a failure of sending, but may not receive an Msg4; or, no response message is received within the preset time period. It may be considered in both the two cases that contention-based random access of the UE fails. A failure of the contention-based random access of the UE may be caused by that the UE fails to contend due to simultaneous access of other UEs.

Step 206: The UE determines whether the UE identifier in the Msg4 is consistent with the UE identifier in the Msg3; and when the UE determines that the UE identifier in the Msg4 is consistent with the UE identifier in the Msg3, step 207 is performed, or when the UE determines that the UE identifier in the Msg4 is not consistent with the UE identifier in the Msg3, step 208 is performed.

Step 207: The contention-based random access of the UE is successful, and the UE establishes a radio connection with the eNB.

Step 208: The contention-based random access of the UE fails, and the UE sends a next random access request to the eNB; and step 209 is performed.

Here, a re-access timer may be started, and it is determined whether a response message is received before the re-access timer is started. If no response information, no message indicating a failure of sending or no message indicating a failure of contention-based access is received before the re-access timer is started, the UE may determine that the contention-based random access of the UE fails. Then, the UE sends a next random access request to the eNB. For details of the next random access request, reference may be made to step 200.

Step 209: The UE receives a next RAR sent from the eNB; and step 210 is performed.

As the same as step 201, the next RAR here is also assigned for the UE by the eNB according to the received next random access request.

Step 210: The UE parses the next RAR to obtain next uplink grant information; and step 211 is performed.

Step 211: The UE determines whether the next uplink grant information is consistent with previous uplink grant information; and if consistent, step 213 is performed; otherwise, step 212 is performed.

Step 212: The UE performs data scheduling and packetization again according to the next uplink grant information to generate a new Msg3, and at the same time, uses the Msg3 to update the Msg3 generated by scheduling and packetization last time; and step 213 is performed.

Step 213: The UE sends the Msg3 to the eNB; at the same time, a timer is started; and step 214 is performed.

It should be noted that, when the UE determines that the next uplink grant information is consistent with the previous uplink grant information, the Msg3 sent by the UE to the eNB is the Msg3 obtained by scheduling and packetization last time; and when the UE determines that the next uplink grant information is not consistent with the previous uplink grant information, data scheduling and packetization is performed again according to the next uplink grant information in the preceding step to generate a new Msg3, and the new Msg3 updates the previous Msg3.

Step 214: Determine whether an Msg4 sent from the eNB is received within a preset time period set by the timer; and if the Msg4 sent from the eNB is received within the preset time period, step 215 is performed, or if the Msg4 sent from the eNB is not received within the preset time period set by the timer, step 208 is performed.

Step 215: The UE determines whether a UE identifier in the Msg4 is consistent with a UE identifier in the Msg3; and when the UE determines that the UE identifier in the Msg4 is consistent with the UE identifier in the Msg3, step 207 is performed, or when the UE determines that the UE identifier in the Msg4 is not consistent with the UE identifier in the Msg3, step 208 is performed.

With the random access processing method in this embodiment, the current uplink grant information in the current RAR information received by the UE from the eNB is compared with the pre-stored uplink grant information in the previous RAR, and when the current uplink grant information is different from the pre-stored uplink grant information, data scheduling and packetization is performed according to the current uplink grant information to generate a first data packet carrying a UE identifier; and the first data packet is sent to the eNB. In this way, a situation in the prior art, where the data packet obtained by scheduling and packetization according to the grant information in the RAR received during the previous access request is still sent to the eNB when the current grant information is different from the previous grant information, is changed. Therefore, by using the technical solution in this embodiment, the success rate of random access of the UE can be effectively improved.

The technical solution in this embodiment of the present invention may be applied to a Time Division Duplexing (hereinafter referred to as TDD)-mode LTE system.

Persons of ordinary skill in the art may understand that all or a part of the steps of the method in the embodiments may be implemented by a program instructing relevant hardware. The program may be stored in a computer readable storage medium. When the program runs, the steps of the method in the embodiments are performed. The storage medium may include any medium that is capable of storing program codes, such as an ROM, an RAM, a magnetic disk, or a compact disk.

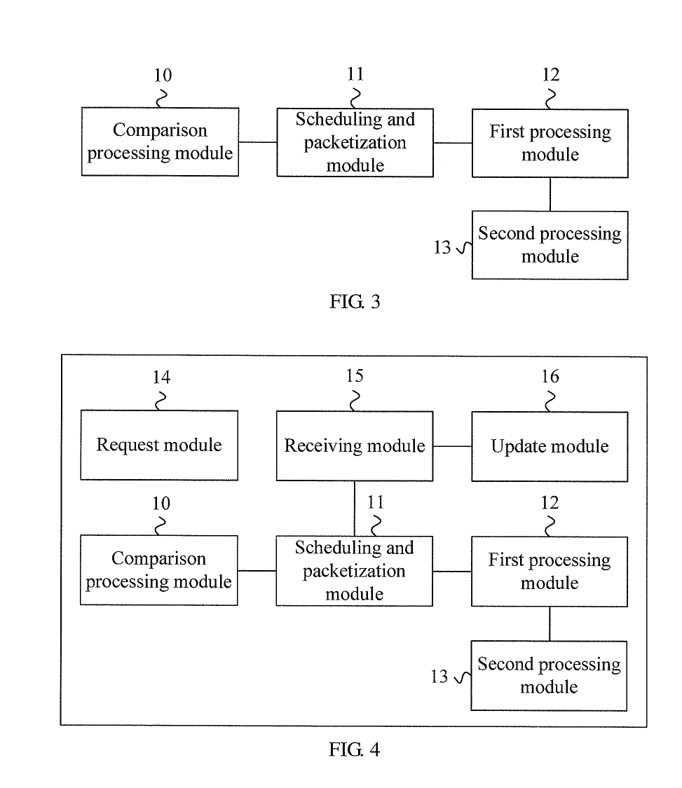

FIG. 3 is a schematic structural diagram of a UE according to a third embodiment of the present invention. As shown in FIG. 3, the UE in this embodiment may specifically include a comparison processing module 10, a scheduling and packetization module 11, a first processing module 12 and a second processing module 13.

The comparison processing module 10 is configured to compare current uplink grant information in current RAR information with pre-stored uplink grant information after receiving the current RAR information sent from an eNB, where the pre-stored uplink grant information is uplink grant information in previous RAR information received in a previous random access process. The scheduling and packetization module 11 is connected to the comparison processing module 10, and the scheduling and packetization module 11 is configured to perform data scheduling and packetization according to the current uplink grant information to generate a first data packet carrying a UE identifier when the comparison processing module 10 determines that the current uplink grant information is not consistent with the pre-stored uplink grant information by comparison. The first processing module 12 is connected to the scheduling and packetization module 11, and the first processing module 12 is configured to send the first data packet generated by the scheduling and packetization module 11 to the eNB, so that the eNB generates, according to the first data packet, a second data packet carrying an identifier of a UE corresponding to the first data packet, and sends the second data packet to the UE. The first processing module 12 is further configured to receive the second data packet from the eNB. The second processing module 13 is connected to the first processing module 12, and the second processing module 13 is configured to parse the second data packet received by the first processing module 12, and determine whether contention-based random access is successful according to a parsing result.

With the UE in this embodiment, the random access processing process implemented by the preceding modules is the same as the implementation mechanism of the preceding relevant method embodiments. Reference may be made to the description of the preceding relevant method embodiments for details, and therefore, the details are not described here again.

With the UE in this embodiment, through the preceding modules, the current uplink grant information in the current RAR information received by the UE from the eNB is compared with the pre-stored uplink grant information in the previous RAR, and when the current uplink grant information is different from the pre-stored uplink grant information, data scheduling and packetization is performed according to the current uplink grant information to generate a first data packet carrying a UE identifier; and the first data packet is sent to the eNB. In this way, a situation in the prior art, where the data packet obtained by scheduling and packetization according to the grant information in the RAR received during the previous access request is still sent to the eNB when the current grant information is different from the previous grant information, is changed. Therefore, by using the technical solution in this embodiment, the success rate of random access of the UE can be effectively improved.

It should be noted that, the comparison processing module 10 in the preceding embodiment is specifically configured to compare a size of a TB of the current uplink grant information in the current RAR information with a size of a TB of the pre-stored uplink grant information. Reference may be made to the description of the relevant method embodiments for details, and therefore, the details are not described here again.

FIG. 4 is a schematic structural diagram of a UE according to a fourth embodiment of the present invention. As shown in FIG. 4, the UE in this embodiment includes the basic solution of the embodiment shown in FIG. 3, and specifically, may further include a request module 14 and a receiving module 15.

The request module 14 is configured to send a current random access request to an eNB. The receiving module 15 is configured to receive a current RAR sent from the eNB according to the current random access request. The receiving module 15 is connected to the comparison processing module 10, and specifically, the comparison processing module 10 is configured to compare current uplink grant information in the current RAR information received by the receiving module 15 with pre-stored uplink grant information.

It should be noted that, the UE in this embodiment may further include an update module 16, where the update module 16 is connected to the receiving module 15, and the update module 16 is configured to update the pre-stored uplink grant information to the current uplink grant information after the first processing module 12 sends the first data packet to the eNB, so as to ensure the accuracy of pre-stored uplink grant information in a next random access request process.

With the UE in this embodiment, the random access processing process implemented by the preceding modules is the same as the implementation mechanism of the preceding relevant method embodiments. Reference may be made to the description of the preceding relevant method embodiments for details, and therefore, the details are not described here again.

The UE in this embodiment can improve the success rate of random access of the UE more effectively by adding the preceding technical solution.

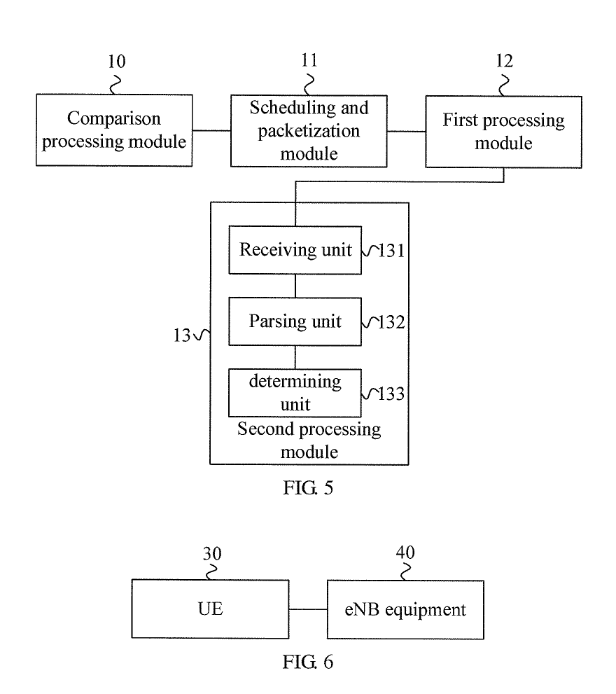

FIG. 5 is a schematic structural diagram of a UE according to a fifth embodiment of the present invention. As shown in FIG. 5, the UE in this embodiment includes the basic solution of the embodiment shown in FIG. 3, and specifically, the second processing module 13 may further include a receiving unit 131, a parsing unit 132 and a determining unit 133.

The receiving unit 131 is connected to the first processing module 12, and the receiving unit 131 is configured to receive a second data packet from the first processing module 12. The parsing unit 132 is connected to the receiving unit 131, and the parsing unit 132 is configured to parse the second data packet received by the receiving unit 131 to obtain a UE identifier in the second data packet. The determining unit 133 is connected to the parsing unit 132, and the determining unit 133 is configured to compare the UE identifier obtained through parsing by the parsing unit 132 with a UE identifier carried in a first data packet, and determine that contention-based random access is successful if the two are consistent; otherwise, determine that the contention-based random access fails.

The technical solution added in this embodiment may also be added on the basis of the embodiment shown in FIG. 4, and the details are not described here again.

With the UE in this embodiment, the random access processing process implemented by the preceding modules is the same as the implementation mechanism of the preceding relevant method embodiments. Reference may be made to the description of the preceding relevant method embodiments for details, and therefore, the details are not described here again.

The UE in this embodiment may rapidly and accurately determine the success of random access of the UE by adding the preceding technical solution.

FIG. 6 is a schematic structural diagram of a random access processing system according to a sixth embodiment of the present invention. As shown in FIG. 6, the random access processing system in this embodiment may specifically include a UE 30 and eNB equipment 40. The UE 30 is connected to the eNB equipment 40.

The UE 30 is configured to compare current uplink grant information in current RAR information with pre-stored uplink grant information after receiving the current RAR information sent from the eNB equipment 40, where the pre-stored uplink grant information is uplink grant information in previous RAR information received from an eNB in a previous random access process; perform data scheduling and packetization according to the current uplink grant information to generate a first data packet carrying a UE identifier when the current uplink grant information is not consistent with the pre-stored uplink grant information; and send the first data packet to the eNB equipment 40. The eNB equipment 40 is configured to receive the first data packet sent from the UE 30, generate, according to the first data packet, a second data packet carrying an identifier of the UE 30 corresponding to the first data packet, and send the second data packet to the UE 30. The UE 30 is further configured to receive the second data packet sent from the eNB equipment 40; parse the second data packet; and determine whether contention-based random access of the UE 30 is successful according to a parsing result.

The UE 30 in this embodiment may specifically adopt the UE described in the third embodiment to the fifth embodiment. Reference may be made to the description of the preceding embodiments for details, and therefore, the details are not described here again.

With the random access processing system in this embodiment, the random access processing process implemented by the UE and the eNB equipment is the same as the implementation mechanism of the preceding method embodiments. Reference may be made to the description of the preceding relevant method embodiments for details, and therefore, the details are not described here again.

With the random access processing system in this embodiment, the UE compares the current uplink grant information in the current RAR information received from the eNB with the pre-stored uplink grant information in the previous RAR, and when the current uplink grant information is different from the pre-stored uplink grant information, performs data scheduling and packetization according to the current uplink grant information to generate a first data packet carrying a UE identifier; and sends the first data packet to the eNB equipment. In this way, a situation in the prior art, where the data packet obtained by scheduling and packetization according to the grant information in the RAR received during the previous access request is still sent to the eNB when the current grant information is different from the previous grant information, is changed. Therefore, by using the technical solution in this embodiment, the success rate of random access of the UE can be effectively improved.

The device embodiments described in the preceding are merely exemplary. Units described as separate components may be or may not be physically separated. Components shown as units may be or may not be physical units, that is, may be located in one place or may be distributed to at least two network units. A part or all of the modules may be selected to achieve the objective of the solutions of the embodiments according to actual demands. Persons of ordinary skill in the art may all understand and implement the present invention without making creative efforts.

Finally, it should be noted that the preceding embodiments are merely used for describing the technical solutions of the present invention, but not intended to limit the present invention. It should be understood by persons of ordinary skill in the art that although the present invention has been described in detail with reference to the embodiments, modifications may still be made to the technical solutions described in the embodiments, or equivalent replacements may be made to some technical features in the technical solutions, however, these modifications or replacements do not make the essence of the corresponding technical solutions depart from the spirit and scope of the technical solutions in the embodiments of the present invention.

What is claimed is:

1. A random access processing method, comprising:
comparing current uplink grant information in current Random Access Response (RAR) information with pre-stored uplink grant information after receiving the current RAR information sent from an evolved Node B (eNB), wherein the pre-stored uplink grant information is uplink grant information in previous RAR information received in a previous random access process;
performing data scheduling and packetization according to the current uplink grant information to generate a first data packet carrying a User Equipment (UE) identifier when the current uplink grant information is not consistent with the pre-stored uplink grant information;
sending the first data packet to the eNB, and receiving a second data packet from the eNB; and
parsing the second data packet, and determining whether contention-based random access is successful according to a parsing result.

2. The random access processing method according to claim 1, wherein comparing the current uplink grant information in the current RAR information with the pre-stored uplink grant information comprises: comparing a size of a Transport Block (TB) of the current uplink grant information with a size of a TB of the pre-stored uplink grant information to determine whether the current uplink grant information is consistent with the pre-stored uplink grant information.

3. The random access processing method according to claim 1, wherein before receiving the current RAR information sent from the eNB, the method further comprises:
sending a current random access request to the eNB.

4. The random access processing method according to claim 1, further comprising:
updating the pre-stored uplink grant information to the current uplink grant information.

5. The random access processing method according to claim 1, wherein parsing the second data packet, and determining whether the contention-based random access is successful according to the parsing result comprises:
parsing the second data packet to obtain a UE identifier in the second data packet; and
comparing the obtained UE identifier with the UE identifier carried in the first data packet, and determining that the contention-based random access is successful if the obtained UE identifier and the UE identifier carried in the first data packet are consistent, and determining that the contention-based random access fails if the obtained UE identifier and the UE identifier carried in the first data packet are not consistent.

6. The random access processing method according to claim 1, wherein the first data packet is a data packet of a Radio Resource Control (RRC) connection request and the second data packet is a data packet of a contention resolution message.

7. A User Equipment (UE), comprising:
a comparison processing module, configured to compare current uplink grant information in current Random Access Response (RAR) information with pre-stored uplink grant information after receiving the current RAR information sent from an evolved Node B (eNB), wherein the pre-stored uplink grant information is uplink grant information in previous RAR information received in a previous random access process;
a scheduling and packetization module, configured to perform data scheduling and packetization according to the current uplink grant information to generate a first data packet carrying a UE identifier when the current uplink grant information is not consistent with the pre-stored uplink grant information;
a first processing module, configured to send the first data packet to the eNB, and receive a second data packet from the eNB; and
a second processing module, configured to parse the second data packet, and determining whether contention-based random access is successful according to a parsing result.

8. The UE according to claim 7, wherein the comparison processing module is configured to compare a size of a Transport Block (TB) of the current uplink grant information with a size of a TB of the pre-stored uplink grant information to determine whether the current uplink grant information is consistent with the pre-stored uplink grant information.

9. The UE according to claim 7, further comprising:
an update module, configured to update the pre-stored uplink grant information to the current uplink grant information.

10. The UE according to claim 7, wherein the second processing module comprises:
a receiving unit, configured to receive the second data packet from the first processing module;
a parsing unit, configured to parse the second data packet to obtain a UE identifier in the second data packet; and
a determining unit, configured to compare the obtained UE identifier with the UE identifier carried in the first data packet, and determine that the contention-based random access is successful if the obtained UE identifier and the UE identifier carried in the first data packet are consistent, and determine that the contention-based random access fails if the obtained UE identifier and the UE identifier carried in the first data packet are not consistent.

11. A computer-readable storage medium, comprising computer program codes which when executed by a computer processor cause the compute processor to execute process of:
comparing current uplink grant information in current Random Access Response (RAR) information with pre-stored uplink grant information after receiving the current RAR information sent from an evolved Node B (eNB), wherein the pre-stored uplink grant information is uplink grant information in previous RAR information received in a previous random access process;
performing data scheduling and packetization according to the current uplink grant information to generate a first data packet carrying a User Equipment (UE) identifier when the current uplink grant information is not consistent with the pre-stored uplink grant information;
sending the first data packet to the eNB, and receiving a second data packet from the eNB; and
parsing the second data packet, and determining whether contention-based random access is successful according to a parsing result.
